(19) United States
(12) Patent Application Publication
(10) Pub. No.: US 2025/0001588 A1
(43) Pub. Date: Jan. 2, 2025

(54) APPARATUS AND METHOD FOR PROGRAMMING ROBOTS BY DEMONSTRATION

(71) Applicant: GLANCE VISION TECHNOLOGIES S.R.L., Trieste (IT)

(72) Inventors: Walter Vanzella, Trieste (IT); Andrea Felice Pellegrino, Trieste (IT)

(73) Assignee: GLANCE VISION TECHNOLOGIES S.R.L., Trieste (IT)

(21) Appl. No.: 18/703,695

(22) PCT Filed: Oct. 25, 2022
(86) PCT No.: PCT/IB2022/060252

§ 371 Date: Apr. 22, 2024

(30) Foreign Application Priority Data
Oct. 26, 2021 (IT) 102021000027485

(51) Int. Cl. B25J 9/00; B25J 19/02

(52) U.S. Cl. CPC B25J 9/0081; B25J 19/023

(57) ABSTRACT

The present invention relates to an apparatus for programming robots based on a novel passive pointing device including fiducial markers which enables interaction with one or more cameras through a computer implemented method. By taking advantage of a camera integral to the robot. the computer implemented method and the pointing device enable a tracking mechanism that during robot programming makes possible to change the position of the robot in real time in order to maintain substantially constant the relative pose between the on-board camera and the pointing device. In this way, the human operator can advantageously set the poses of the robot tool by means of demonstration i.e., by placing the pointer in the desired position and orientation during execution of the computer implemented method. With respect to known systems, larger working-space and higher precision, adjustable according to needs, are thus achieved. The apparatus may include a passive pointer and a camera mounted on the robot's wrist.

### TECHNICAL FIELD

The present invention relates to devices and methods for programming robots, particularly collaborative robots, i.e., cobots.

### BACKGROUND ART

Robots have increasingly become essential machines in performing various activities, often dangerous, in the industry or other fields. Currently, various types of robots are available: anthropomorphic, SCARA, parallel, humanoid. They can be subdivided according to size, load capacity, speed. Just to demonstrate how broad is the term “robot”, well-known autonomous household devices used for cutting grass or dust vacuum are indeed robots.

For the purposes of illustrating the present invention, robots can be substantially divided into two large families: traditional robots and collaborative robots, also termed “cobots”.

The former operates in controlled environments, where strict safety measures are required. In particular, the operator must remain at a safe distance during execution of the work cycle. Conversely, cobots can operate close to the operator with whom they actively collaborate. Clearly, they require the adoption of measures to ensure the safety of the human operator. Typically, they are equipped with force sensors. Therefore, cobots are able to detect collisions and can stop when they hit a person.

In the past and still today, the programming step of a collaborative robot (and also of a traditional robot) is performed according to a standard mode that in summary requires: moving the tool mounted on the robot; verifying its position; recording the pose of the tool i.e., the position and inclination. This procedure is generally very time-consuming due to the considerable number of poses that may be required to model even a medium complexity industrial process.

In the case of traditional robots, positioning of the tool in the various poses according to the pre-defined sequence of operations is done by means of a specific device named “teach pendant”. Said device is generally supplied with the robot and consists of a portable console having an interface that the operator uses to move the tool in the space directions, set each single pose of the sequence and memorize or delete specific poses. This instruction method of the robot is often termed “point-to-point” programming.

The teach pendant can possibly be equipped with a camera which facilitates remote assistance (as claimed in document WO2010130289A1 in the name of ABB Research Ltd), or generates an augmented reality environment to facilitate robot programming (as claimed in the applications US2021023694A1 and US2020384647A1 in the name of, respectively, Qingdao University and Fanuc Corp).

In case of collaborative robots, however, the positioning of the cobot in the pre-defined poses requires a teach pendant or, alternatively, requires “kinesthetic teaching” a special programming mode in which the cobot can be manually dragged and positioned in the various poses with little effort by the operator.

Kinesthetic teaching (for example, is described in the application WO2017/178469 in the name of Universal Robots A/S), is extremely time-consuming because the operator has to position the cobot in every pose required by the sequence of operations of the program. In addition, fine positioning, i.e. very accurate tool positioning, typically requires further adjustments made via the teach pendant.

Cameras and reference markers are widely used in robotics. A solution that uses both of them is for example described in the application WO2021050646A1 in the name of DMG Mori Co Ltd and Skylla Tech. This document relates to a device mounted on a robot that can be moved around a machine tool. A camera mounted on the robot arm detects an “identification figure” placed on a flat ceramic surface. The purpose is to enable the use of the robot in a plurality of work stations and to ensure that after the robot is moved from one station to the other, it is still positioned in the same way the robot was positioned in the first station. However, the use of reference markers disclosed in WO2021050646A1 is not useful for setting up a device and a method for programming a robot, particularly a cobot.

Cameras and reference markers are widely used also in calibration of robotic arms (knowns example are provided for example by US2020198145A1 in the name of Industrial Technology Research Institute and U.S. Pat. No. 7,945,349B2 in the name of ABB Technology AB). This purpose is totally different from the object of the present invention and it is useless for those skilled in the art wishing to develop a device and method for programming a robot.

A noticeably solution addressed to robots programming, which is relevant for the present invention, is disclosed in the US patent U.S. Pat. No. 7,353,081B2 (or in the family equivalent application US2005251290A1) in the name of ABB Research Ltd.

More in detail, U.S. Pat. No. 7,353,081B2 discloses a method for programming a robot by means of a pointer and a camera. The method comprises the steps of obtaining an image detected by a camera of the object to be processed and obtaining information on the position of a pen-like shaped pointer placed on or near the object. Remarkably, the pointer is an active device i.e., it includes a dedicated electronic unit and associated keys for acquiring the position and orientation of the pointer. In addition, the camera is held in a suitable fixed point of the workspace or is attached to the operator's head (or elsewhere on his body). However, this patent specification does not suggest that the camera may be fixed directly on the robot to be trained and in particular on the wrist of the robot.

Particularly, an embodiment of U.S. Pat. No. 7,353,081B2 refers to a method for programming a robot based on image recognition in which two markers are used (FIG. 1): a so-called “reference marker”, in fixed relationship with the object, and a “pointing marker” attached to the pointer. In practice, the function of the reference marker is recognizing where the pointer is with respect to the reference coordinate system given by the reference marker. With regard to this, it is worth to note that for the purposes of implementing U.S. Pat. No. 7,353,081B2, the markers must be distinct and asymmetrical so that they can be recognized from any angle by means of the image recognition algorithm.

Despite being an improvement of technology related to tools and methods for programming a robot based on cameras and pointers, it is evident that U.S. Pat. No. 7,353,081B2 presents significant disadvantages.

A first disadvantage consists in that the pointer is an active device and therefore has a relatively high cost. Furthermore, since the pointer localization procedure is based on a “world reference system”, the implementation of the method and system according to U.S. Pat. No. 7,353,081B2 requires at least two patterns, which must both be within the camera's field of view. If the camera is not able to frame one of the pattern, the usable workspace is reduced and the operator has to stop robot programming, displace the robot in a suitable position and continue programming.

An additional disadvantage is the result of the camera which is not mounted on board the robot. This configuration intrinsically determines poor performance in terms of positioning precision as well as constancy and optimality of the camera point of view.

Finally, U.S. Pat. No. 7,353,081B2 does not teach nor suggest to those skilled in the art any pattern tracking mechanism.

To sum up, the limitations of current technologies are related to costs, difficult installation (e.g. related to illuminators or other cameras positioning), usable workspace and low level of precision in acquiring the pose.

In conclusion, for the reasons set out above, the problem of programming a robot, particularly a cobot, has not fully addressed yet, and it is desirable to have an improved solution based on the use of one or more cameras and a pointer device, in particular a passive pointing device.

### DISCLOSURE OF INVENTION

### Object/Scope of the Invention

In view of the above, the present invention intends to overcome the existing disadvantages and drawbacks of the prior art by providing a novel and innovative apparatus and method for programming robots, particularly collaborative robots.

Therefore, the first and main object of the present invention is to provide an apparatus for programming robots based on a pointing device, simple to use, which does not use any electronics system to calculate the pose, or which does not include any electronics system even to communicate with the computing unit.

A second important object of the present invention is to provide said apparatus so that it has a high precision that can be adjusted according to the needs of the specific application.

A third important object of the present invention is to provide an apparatus and a method for programming robots which is able to exploit the intrinsic repeatability of the robot.

A fourth important object of the present invention is to provide a method to increase the teaching workspace without external sensors or external camera repositioning.

Finally, a last object of the present invention is to provide an apparatus for programming collaborative robots and a method thereof which can be produced or implemented in a simple and economical way by means of known technologies.

### Technical Solution and Inventive Concept

These and still other purposes, which will appear more clearly in the specification which follows, are achieved by an apparatus for programming robots, a robot which includes said apparatus, and by a method for programming robots.

The invention is defined by the appended independent claims 1, 12 and 15 while advantageous features are set forth in the appended dependent claims. The aforesaid claims, to which reference should be made for the sake of brevity, are hereinafter specifically defined and are intended as an integral part of the present specification.

In summary, a first object of the patent is an apparatus for programming robots based on a substantially passive, or a totally passive, pointing device which includes a single target consisting of one or more markers arranged in a pattern, as well as on one or more cameras that interact with said target.

Preferably, said apparatus is based on a single camera integral with the robot and a totally passive pointing device having a pattern on it consisting of a plurality of markers, preferably six markers. Furthermore, in the present specification the term “substantially passive” referred to the pointing device shall mean a pointing device including an electronic unit. However, such electronic unit is not used to calculate the pose of the pointer in space, nor to send signals (e.g., electromagnetic signals) useful for such purpose, but it enables only communication with the processing unit where such calculations are performed.

Similarly, the term “totally passive” shall mean a pointing device which does not include any electronic unit neither electronics for communication with the computing unit where the pose is calculated.

For the sake of clarity, in the present specification the term “pose” shall mean the position and orientation in space of the pointing device and hence of the robot tool.

For the sake of clarity in the present specification the term “working space” shall mean the set of poses that the robot can reach. The term “teaching workspace” shall mean the place where poses of the pointing device can be detected i.e. where the robot is instructed according to the method of the present invention.

Preferably the robot is a collaborative robot i.e., a cobot although it may be of another type such as an industrial robot or a humanoid robot.

In preferred embodiments the camera is mounted on-board on the wrist of the robot or on other moving components of the robot such as an external axis or a carriage. In alternative embodiments, in addition to the on-board camera, one or more fixed cameras are included in the environment within which the robot operates.

Typically, the pointing device, or pointer, is a pen-shaped device which is positioned by the operator in the working space to determine the pose of the pointer, and hence of the robot tool, at a certain step of the work-cycle to be translated in a program for the robot.

The pose of the pointing device is estimated by one or more cameras and a computational vision algorithm based on “fiducial markers”. Such algorithm enables a tracking mechanism of the pointer, which makes possible for the robot to change its position in a way that the relative pose between camera and pointing device during programming is maintained constant or variable within a predefined range.

Thanks to such tracking mechanism, the programming apparatus achieves high precision, consistency and optimality, and larger teaching workspace.

These remarkable features depend on geometric parameters such as the distance between the markers and the pointer tip, the distance of the camera from the markers, the distance between the markers within the pattern. Said parameters are considered in the design stage of the apparatus to adjust precision according to requirements of a specific application. For example, a limited space available for maneuver in the workspace may require a greater distance between the camera and the target, which can be compensated for by enlarging the configuration of the markers or by positioning the target closer to the tip of the pointer.

The pointing device, the robot, or the processing unit where the pose estimation and tracking code is performed, may be equipped with interacting means to enable interaction with the operator (e.g., keys, buttons, gestural or vocal interaction systems) which allows to acquire and store the current pose, to delete the last stored pose and to carry out other operations aimed at the construction and manipulation of a sequence of poses forming a “poses path”. Such a poses path makes up the robot program or represents the starting point to generate or modify the robot program.

In a preferred embodiment, the interaction with the operator advantageously excludes the use of electronics dedicated to communication with the computing unit. Interaction is based on Artificial Intelligence (AI) algorithms designed to, first, interpret hands movements (or other gestures) of the operator, and second, trigger operations on the pose.

Advantageously, in a preferred embodiment, the programming method according to the present invention does not require a “teach-pendant” device, nor require off-line programming and hence it is extremely fast and intuitive.

In an alternative embodiment, said method may be used in association with a “teach-pendant” device, to guarantee the maximum stability of the pointing device in high precision applications. Furthermore, differently from known robot programming systems (in particular U.S. Pat. No. 7,353,081B2), the solution herein provided requires the use of a single target, integral with the pointer, since the determination of the pose does not depend on the position of the pointer with respect to a “world reference system” and it is limited to its position with respect to the camera. This feature greatly improves precision in pose calculation.

When the camera is fixed to the robot's wrist, by means of the target tracking mechanism it is possible to overcome the issue of limitations in the teaching workspace, which in the traditional robot programming systems are related to the need to detect more than one target at the same time. Furthermore, the tracking system avoid the visual occlusions of the markers, which represents a serious problem when fixed camera configurations are used, because it makes programming very time-consuming. In fact, when this event occurs, the instructor is forced to displace the robot, or remove the occlusion, and resume or restart the teaching session.

Finally, when the apparatus includes one or more additional cameras to frame the work area in a fixed position with respect to the robot, it is also possible to alert any dangerous positions of the user or dangerous behavior, as well as anomalies in the teaching method according to the present invention.

### BRIEF DESCRIPTION OF DRAWINGS

The present invention will be more fully understood by reference to the following drawings which are provided solely for illustration of the embodiments and not limitation thereof:

FIG. 1 illustrates the first preferred embodiment of the present invention, wherein the apparatus for programming includes a single on-board camera.

FIG. 2 illustrates, in (a), the pointing device according to the invention, showing the target with the markers; in (b) the pointing device with the target fixed on top to improve ergonomics; in (c), the pointing device with the target fixed to the lower part of the device to improve accuracy;

FIG. 3 illustrates the second embodiment of the present invention, wherein the apparatus for programming includes one or more fixed cameras other than the single on-board camera.

These figures illustrate and demonstrate various features and embodiments of the present invention but are not to be construed as limiting the invention.

### DETAILED DESCRIPTION OF THE INVENTION

By way of explanation of the invention, and not meant as a limitation thereof, there are provided in the following a detailed description of some preferred, but not exclusive, embodiments of the apparatus and method according to the invention.

### PREFERRED EMBODIMENTS

### Best Embodiment

### Apparatus for programming a cobot

A first object of the present invention is an apparatus for programming a robot which will be described in detail with reference to a first preferred embodiment.

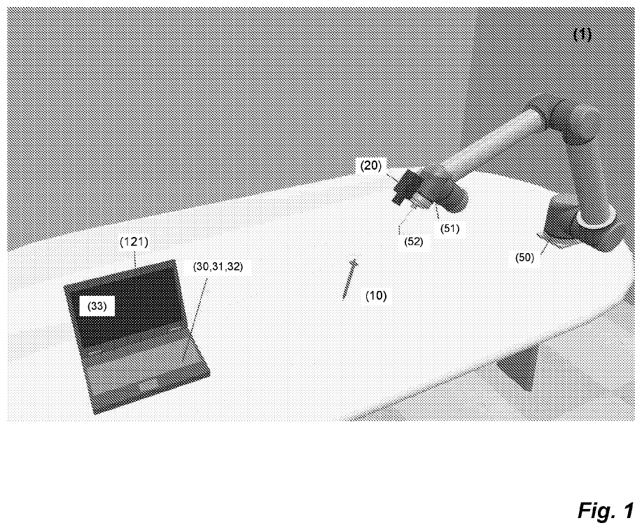

In the first preferred embodiment the apparatus according to the invention includes a single camera which is mounted on-board (i.e., “eye-in-hand”) of a collaborative robot (or cobot). The cobot tracks in real time the pointing device at a certain distance to maintain an optimal shot. As the enclosed FIG. 1 depicts, by way of explanation of the invention, and not meant as a limitation thereof, said apparatus is designated in its entirety with the reference the number (1) and comprises: a pointing device (10), or pointer, having a body (102) shaped in such a way as to facilitate the grip by an operator; a target (11) integral with said pointer (10); a single camera (20) mounted on the wrist (51) of a collaborative robot (50); and a processing unit (30) associated with the device (10) where a software that regulates the programming operation of the cobot is executed.

The body of the pointer (10) is equipped with buttons (12) to enable interaction with the processing unit (30) through a wireless technology such as WiFi or Bluetooth® (trademark of Bluetooth Special Interest Group Inc). However, the events to be communicated can be activated by buttons or keys placed on a separate portable device, preferably the same teach- pendant, which, for example, the operator can hold in the other hand to ensure maximum stability in the positioning and orientation of the pointer especially in high-precision applications.

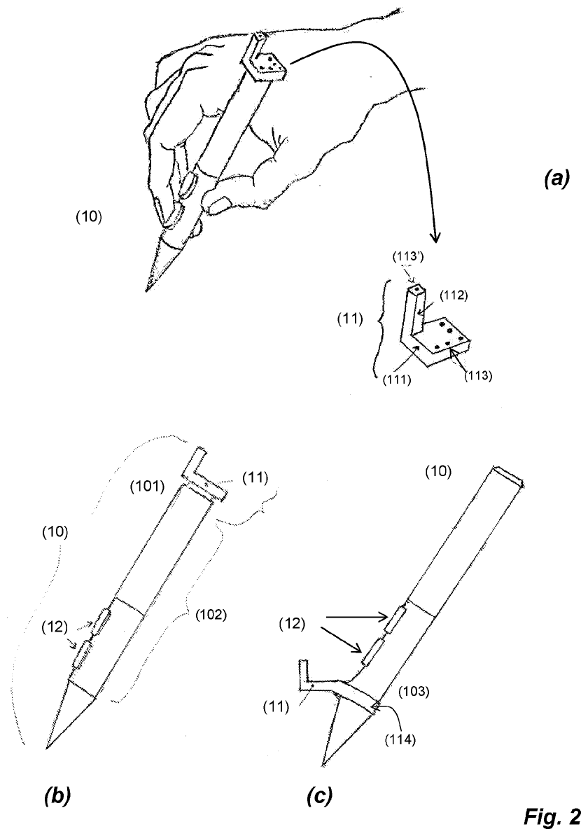

As the enclosed FIG. 2 shows, by way of explanation of the invention, and not meant as a limitation thereof, the target (11) has a body (111) presenting a plurality of markers (113), of known geometric shape, suitably arranged to form a pattern. The body (111) of the target (11) is preferably a plastic parallelepiped although different shapes and materials can be used provided they impart adequate stability and rigidity to the pointer.

Markers (113) are arranged on the target (11) according to a pattern in a way that exhibit a high contrast with the background of the surface, or surfaces, of the body (111) on which they are fixed.

Preferably the markers are black circles on a white background or white circles on a black background. However different shapes and colors can be used depending on needs.

By way of explanation of the invention, and not meant as a limitation thereof, markers (113) may be squares or rhombuses, and may have colors that in the color space are very distant from the background. Markers (113) may be even infrared or ultraviolet reflective as long as they contrast with the background.

Anyhow, a point of space is associated with each marker (113), e.g., by taking as reference the center of each circular marker.

The target (11) of the apparatus (1) for programming robots according to the present invention has at least one protruding element (112), or pillar, on which at least one marker (113′) is fixed in a way that it is positioned outside the plane of the remaining markers (113).

For the purposes of implementation of the present invention, the configuration of the geometric elements of the pattern is not binding: their number can change, as well as their relative distance and the number of pillars (112). For example, the number of markers (13,113′) is six, the spacing between the markers (113, 113′) can be a few millimeters, for example between 3and 4 millimeters. Furthermore, the height of the pillar (112) can be chosen according to needs, typically between 2 and 10 millimeters, preferably 5 millimeters.

In the device (1) for programming robots according to the present invention, the plurality of markers (113,113′) is integral with the pointing device (10) and is fixed to the body (11) of the pointing device by means of a coupling means (114).

Preferably, the target (11) is fixed to the upper part (101) of the pointing device (10). This configuration is preferable when ergonomics of the handle is the main need. However, the target (11) can also be fixed to the lower part (103) of the pointing device (10). This configuration is preferable when precision is the main need.

To allow greater flexibility during cobot programming, it is also possible to slidely engage the target (11) to the body (102) of the pointing device (10). In this configuration, the operator can move the target (11) in a position comprised between a lower part (103), near the tip of the body (102), and an upper part (101) near the end opposite to the tip.

A mechanism of this type capable of ensuring adequate precision in displacement can be produced in a simple way and at low costs with known techniques.

The apparatus (1) for programming robots according to the present invention comprises a single camera (20) which is mounted on the wrist (51) of the collaborative robot (50).

In the first embodiment herein provided by way of explanation of the invention, and not meant as a limitation thereof, the robot (50) is a cobot. However, it can be of a different type, e.g., an anthropomorphic robot or a SCARA robot.

In any case, the robot (50) has an arm having a wrist (51) on which a single camera (20) is mounted. This camera (20) has performances that can be found in products available in the market. Preferably, it is a grey level camera but it can also be an RGB camera or even an infrared sensitive camera based on the characteristics of the target (11) which in turn depend on the specific application the apparatus (1) is addressed to.

Although in the present embodiment the camera (20) is preferably mounted on the wrist (51) of the robot, other positions integral with the robot (50) can be conveniently chosen with the aim of obtaining the best possible framing of the pattern (113). For example, the camera (20) can be fixed to any carriage on which the robot is mounted or, more generally, to a movement axis of the robot as well as to a movement axis not part of the robot but integral to it. Finally, the device (1) according to the present invention comprises a processing unit (30) associated with the pointing device (10) on which a software that regulates the operation of the apparatus for programming the cobot is executed.

In the preferred embodiment, said processing unit (30) is external and resident in a computer external to the cobot (50). However other options are possible: the processing unit (30) may be a “plug-in” module of the robot controller, or the unit (30) may be integrated with the electronics of the camera (20). Combinations of these embodiments are possible.

A computer program is executed in the processing unit (30). The software substantially includes two modules which are essential for the purposes of implementing the present invention: the first module (31) localizes the pattern (113,113′) and provides an estimation of the pose of the pattern (113,113′), and hence of the pointer (10), with respect to the camera (20); the second module (32) enables the dynamic tracking of the marker pattern (113).

Finally, the processing unit (30), which includes a graphic interface (33), interacts with the activation means (12) in a way which is described below.

The tip of the pointer (10) is first placed by the operator in the desired position and orientation; then by executing the first software module (31) the marker pattern (113,113′) and hence the pose (i.e. position and orientation) of the tip can precisely be detected.

By acting on the buttons (12) in the handle of the pointer body (10), the operator communicates to the processing unit (30) the selected options. By way of explanation of the invention, and not meant as a limitation thereof, said options may include: memorization of the current pose, storing a sequence of poses in continuous mode, deleting the last pose, or a sequence of stored poses. In the continuous acquisition mode, the processing unit (30), in association with the software (31), detects the pose at each predetermined time interval (which can be set by the user) as the operator moves the pointer (10) along a path.

In this way, while the pointing device (10) is in motion, a plurality of poses can be recorded, as well as the trajectories i.e. individual positions and speed between a position and another one. This mode is particularly useful when it is needed to replicate the movement made by a human operator in a working process, e.g., painting.

Clearly, the poses path can be acquired by mounting the pointing device (10) on an arm moved by an actuator or on a robot. This mode is useful in applications performed in dangerous environments where the operator must not be present. Furthermore, the path of poses according to the instruction of an “instructor” robot can be easily and automatically copied on a “learner” robot, having the pointing device (10) mounted on it.

The coordinates of the points stored up to a given instant of the programming step can be displayed in the graphic interface (33) of the processing unit (30). The graphic interface (33) also allows adjustment of functional parameters required by the software modules (31,32).

Advantageously, the graphical interface (33) allows to overlap, to the images acquired by the camera in real time (20), the points already stored and recalculated on the basis of the current position of the robot so as to be shown integral with the object e.g., to be machined.

As the enclosed FIG. 1 illustrates, by way of explanation of the invention, and not meant as a limitation thereof, the camera (20) mounted on the wrist (51) of the cobot (50) can communicate with the processing unit (30) via cable or wireless depending on the amount of data required and the disturbances in the industrial environment.

The camera (20) frames the marker pattern (113.113′) and, thanks to the second software module (32), tracks the pointer (10) i.e., it moves the robot (50) in such a way that the pattern is always framed while the pointer (10) is maintained at a desired distance and angle.

This allows to track the pointer (10) while the operator uses it, remaining at an ideal distance for localization in order to reduce the overall error in positioning and orientation. Although all this will be explained in detail below, we point out that there exist more favorable angles for framing, by taking into account, for example, camera optics which has ideal working distances Finally, the device (1) according to the present invention can use a first calibration tool for standard cameras and a second calibration tool for the pointer (10) which implement some functions in a similar way to known calibration tools. In particular, such tools automatically estimate, on the basis of a set of acquired images, some characteristic distances of the pointer (10) such as the position of the tip (101, 103) with respect to the reference system of the pattern (113,113′), or the position of the tool (52) of the robot (50) with respect to the reference system of the camera (20).

From the description provided, it will be evident to those skilled in the art how the device (1) for programming robots according to the invention makes use of components of very low cost. In addition, the software modules (31,32) can be executed on processing units already present in the system, lowering costs further. The apparatus (1) achieves very high accuracies, higher than other solutions already present on the market thanks to the software modules (31,32) and the camera mounted on the wrist of the cobot.

In a prototype of a cobot according to the present invention, with a standard set-up, the present inventors have achieved precision of about 0.4 mm. More precisely, the tests carried out with such prototype made it possible to quantify in 0.4 mm the maximum distance between the programmed position of the pointer tip, set in the programming step, and the actual position reached by the tool once the robot is positioned on the programmed position after that it is retrieved from the memory.

However, it is possible to reach even higher accuracies, compatibly with the intrinsic precision (repeatability) of the robot (50) which represents the real limit to further improvements, as will be explained in detail below. In fact, precision depends on a number of parameters: the calibration of the camera (20), the framing distance, the size and position of the pattern (113,113′) with respect to the tip (101, 103). All parameters may be adjusted according to requirements of a specific application.

### Method of Programming a Cobot

A second object of the present invention is a method for programming a robot which will be described in detail with reference to the first preferred embodiment.

From the description provided above, it is clear that the apparatus described above (1) allows an operator to set the position and orientation in space of the tool of a robot (50) by means of a method which includes the following steps:
a) make a mobile camera (20) integral with the robot (50), preferably by fixing it to the wrist (51) of said robot (50);
b) place a pointing device (10) having a marker pattern (113,113′) in said working space;
c) frame the marker pattern (113.113′) on said pointing device (10) by means of said mobile camera (20);
d) execute a software in a processing unit (30) associated with the pointing device (10), said software comprising instructions that cause a movement of the robot (50) such as to track the pattern (113, 113′) while the operator, or other means, holds said pointing device (10), i.e. such as said pattern (113,113′) is framed by said mobile camera (20) remaining at a predetermined distance and inclination while the operator, or other means, holds said pointing device (10), wherein said predetermined distance and inclination are chosen so as to reduce the overall error in positioning and orientation;
e) optionally, change the positioning of the pattern (113.113′) with respect to the tip of said pointing device (10) in order to reduce the overall error in the positioning and orientation of said pointing device (10);
f) acting on the activation means (12) of said pointing device (10), detect the coordinates (x,y,z) and the orientation (α,β,γ) of the pattern (113,113′) with respect to said cameras (20,60) and calculate the pose ((x₀, y₀, z₀), (α₀, β₀, γ₀)) of the pointing device (10) by means of a transformation T_{obj};
g) based on the relative pose ((x₁, y₁, z₁), (α₁, β₁, γ₁)) of said camera (20) with respect to the tool (52) of the robot (50), and the pose ((x₂, y₂, z₂), (α₂, β₂, γ₂)) of the tool (52) with respect to the base of said robot (50), operate a transformation T_{cam/tool} to calculate the pose ((x₃, y₃, z₃), (α₃,β₃,γ₃)) of the pointing device (10) with respect to the robot base (50) and obtain the pose to be detected;
h) store the pose ((x₃, y₃, z₃), (α₃,β₃,γ₃)) calculated in step g) to allow recall and use by the operator as needed.

Advantageously, by means of this method it is possible to track the pointer (10) while the operator uses it, and at the same time it is possible to detect the coordinates (x,y,z) and the orientation (α, β, γ) by keeping the pointer (10) at an optimal distance i.e., at a distance where the overall error on the pose is reduced. The reason is explained in the following.

It is well-known that industrial robots typically have a very high repeatability, which can be defined as the precision in positioning the robot tool in the same pose. Typical repeatability values for industrial robots are less than a tenth of a millimeter. Conversely, the accuracy, which can be defined as the ability to position the robot's tool in the desired point of the workspace is usually much worse, and depends on the point within the workspace considered. In the case of known robot programming systems based on a fixed camera, a priori information of the following rigid transformations (or estimation through experiments) is needed:
T_{ob}: transformation from camera, to pre-defined pose;
Tcₐₘ: transformation from World RS, to camera;
Tr_{ob}: transformation from World RS, to RS robot (usually placed at the base of the robot);
Tₜₒₒₗ: transformation from Robot RS, to robot tool;
T_{cam/tool}: transformation from camera to robot tool.

Such transformations are required (RS designates in short “Reference System”) to position the robot tool in correspondence of an object detected by a camera, or of a selected point in the workspace. Each of these transformations is affected by uncertainty.

In detail, the steps to be taken in a robot programming system based on a fixed camera are:
1. Localize the object with respect to the World RS by applying transformations T_{obj}, T_{cam};
2. Position the robot in the point previously found by applying transformations T_{rob}, Tₜₒₒₗ.

In particular, step 2 depends on the accuracy of the robot (i.e., the ability to position itself exactly in the point of space, which is specified with respect to the World RS) and therefore is potentially affected by a considerable error.

On the other hand, by using an on-board camera and the tracking mechanism according to the present invention, the transformations involved are only two: T_{obj} (the same as in the case of a fixed camera) and T_{cam/tool}, that expresses the pose of the camera with respect to the tool. Hence, the following steps have to be performed to calculate the pose in a robot programming system based on an on-board camera:
1. Localize the object with respect to the tool by applying T_{obj}, T_{cam} and Tₜₒₒₗ transformations;
2. Perform a relative movement of the tool from the current pose (which can be repeated with great precision) to the new pose, calculated at step 1.

It is worth to point out, that the movement is relative, and the transformations with respect to the world reference frame are not involved. Advantageously the uncertainty affecting such transformations has no effect. Furthermore, the accuracy of the robot is involved only in a small movement, i.e., the relative movement, and therefore has a limited effect.

In other words, the accuracy error, which instead would appear if the robot were instructed to place its tool in precise coordinates in 3d space (referred to an external reference system) is circumvented. In this way, since tracking at an optimal distance involves local transformations, when the working path is executed by the same robot used during the teaching operations, the error can be reduced to almost the repetition error i.e. to the intrinsic precision of a robot.

Therefore, since the apparatus and method according to the present invention make use of an on-board camera fixed to the robot's wrist and a tracking mechanism of the pointer, it is possible to exploit the intrinsic repeatability of the robot, as opposed to known solutions based on fixed cameras.

The tracking movement performed by the robot's arm to track the pattern may be designed according to known techniques e.g. “position-based visual servoing” (PBVS). In summary, by means of PBVS the processing unit (30) performs the following operations: the current pose of the camera with respect to the pointer is calculated for the current image; then the calculated pose is compared with the intended pose (i.e. the preferred pose which guarantees to frame the pattern on the pointer from an optimal distance and angle); finally, the roto-translation transform to be applied to the camera is calculated in order to obtain the intended pose.

This roto-translation transform is used as an assigned reference to the control system of the robot. The control system tracks the assigned reference (reference tracking), according to well- known paradigms of feedback control, by using the information of the relative fixed pose between the robot's arm and the camera, which is calculated through known hand-eye calibration algorithms.

In the design step, the optimal distance that minimizes the overall error in positioning and orientation is calculated based on the camera optics.

The angle is calculated within a range that avoids both frames orthogonal to the pattern plane and frames that are too angled. Clearly, orthogonal frames would make the calculation of the pose highly sensitive with respect to errors in the localization of the pattern points, whilst angled frames would make the identification of the pattern points challenging.

Within reasonable limits selected according to the aforementioned criteria, the optimal angle is established through non-trivial systematic laboratory tests and error analysis.

### Other Preferred Embodiments

Further characteristics and advantages of the invention will become apparent from the description of five preferred but not exclusive embodiments thereof.

### Embodiment 2: Single On-Board Camera and Fixed Cameras.

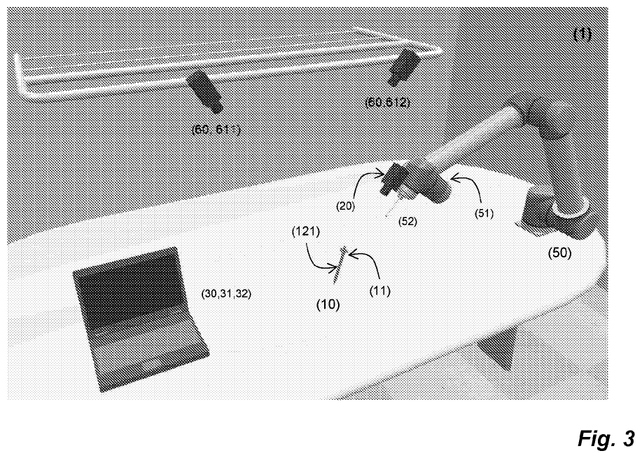

With reference to the FIG. 3, herein enclosed by way of explanation of the invention, and not meant as a limitation thereof, the apparatus (1) according to the second preferred embodiment includes one or more fixed cameras (61) in addition to the camera (20) mounted on the wrist of the cobot (50).

In said embodiment, the fixed cameras (61) include at least one fixed surveillance camera (611) for operator safety purposes, and optionally a fixed tracking camera (612). Preferably said fixed cameras (611,612) are respectively two and one.

The two fixed surveillance cameras (611) are placed in suitable positions that frame the entire workspace and have the purpose of alerting abnormal operator behavior, avoiding collisions between the cobot (50) and the operator or between the cobot (50) and objects within the workspace.

The single fixed tracking camera (612) assist the pattern tracking software (32) when the frame of the on-board camera (20), for any reason, is not locked-in anymore to the marker pattern (113,113′) of the target (11).

The advantage of this configuration is the increase in safety and flexibility of the application in the tracking step.

### Embodiment 3: Single On-Board Camera on a Robot Mounted on a Carriage.

The apparatus (1) according to the third embodiment of the present invention, described by way of explanation of the invention, and not meant as a limitation thereof, may have the same configuration of the previous embodiments 1 or 2. However, the cobot or robot (50) is mounted on a carriage (also named “external axis”) which can be moved along a pre-defined track or path within the working space.

In this way, the pointing device (10) is tracked in real time by the camera (20) integral to the cobot, preferably mounted on the wrist of the cobot, in such a way that the cobot (50), or the camera (2), are displaced at a certain distance (calculated in real time by the processing unit) to maintain the optimal shot while the cobot (50) is moved along the carriage path.

The main advantage of this configuration of the apparatus (1) is that the working space is extended.

### Embodiment 4: Gesture-Based Input.

The fourth embodiment of the apparatus (1) according to the present invention, described by way of explanation of the invention, and not meant as a limitation thereof, includes activation means which exclude buttons (12) or keys in the body (102) of the pointing device (10).

The activation means according to this embodiment can be used with any of the apparatuses described previously.

In this embodiment, the interaction of the pointer (10) with the processing unit (30) is enabled by the same camera (20) thanks to a “click-less” mode i.e., a “gesture-based input” or a “virtual click”. This mode is based on a third software module based on an artificial intelligence algorithm, of the type known in the state of the art. The algorithm interprets gestures or the movement of the hand (or of another anatomical part of the operator), for example the movement of one of the fingers of the operator holding the pointer (10). Accordingly, gestures or movements can be associated with operations which, by way of explanation and not meant as a limitation, shall include one or more of following: memorization of the current pose, memorization of a sequence of poses in continuous mode, deletion of the last pose, or sequence of stored poses.

It is clear from the above, that by using a “gesture-based input” as an activation means (12), the pen is a totally passive item with a negligible production cost.

To facilitate the visual and passive detection of gestures or movements, the operator can advantageously make use of aids, for example a glove worn on the hand, or a ring or a bracelet, having a “target” element easily recognizable by the camera in association with the third software module. Clearly in this way, it is also possible to increase the number of gestures or signs achievable thus providing greater degrees of freedom in demonstrative programming (i.e. through demonstration) through this totally passive mode.

### Embodiment 5: Processing On-Camera.

Finally, the fifth embodiment of the apparatus (1) according to the present invention, described by way of explanation of the invention, and not meant as a limitation thereof, refers to a calculation unit (30) integrated with the camera (20) mounted on the wrist (51) of the robot (50). For example, a smart-camera (30,20) can be used, i.e. a camera equipped with a calculation processor and an operating system that implements the processing required.

The calculation unit (30) according to this embodiment can be used in combination of any of the apparatuses described previously.

The advantage for the user is the overall simplicity of the apparatus (1) in this configuration. It includes only two components, namely the pointing device (10) and the camera (20). Since the most important world producers of cobots provides access to the Software Development Kit (SDK) of the teach-pendant, the interface (33) for adjusting the pointer parameters (10) can be advantageously transferred to the teach-pendant supplied with the robot (50). In this case, the “teach-pendant” is used exclusively for the adjustment of some parameters and not for the programming of the robot (50), which is performed exclusively through the pointing device (10) according to the disclosure of the present invention.

### Advantages and Industrial Application

From the description provided of the apparatus and method for programming a robot, numerous advantages will appear evident to those skilled in the art.

Clearly, the apparatus and method according to the invention simplify and reduce the robot programming task.

A second remarkable advantage of the present invention is cost-cutting as the apparatus includes components of very low-cost and the two software modules can be executed on a low-cost processing unit which may already be part of the robot to be trained or may be an integrated component of the on-board camera. In this way, diffusion of cobots even to very small enterprises can be promoted.

A further advantage, is the wide range of industrial and non-industrial sectors where the apparatus and method for programming robots according to the present invention can be used e.g., surface finishing, welding, textiles, just to mention a few.

However, the main advantage results from the combination of mounting the camera on the robot wrist and the use of a pure vision algorithm. Such a combination enables the pointer tracking mechanism based on the “fiducial markers” described above.

In turn, the tracking mechanism determines three additional benefits.

First, it is possible to keep an optimal frame of the pointer as far as the focus and the angle of view are concerned. Particularly, the angle of view represents an important parameter to avoid ambiguity in the reconstruction of the pose of the target.

A second, and more important, benefit determined by the pointer tracking mechanism is that the positioning error of the cobot in the stored pose mainly depends on the precision of the cobot and not on its accuracy in the same way as if the pose was taken by physically moving the working tool on the 3D point in space.

A third benefit comes from the tracking which intrinsically guarantees the avoidance of visual occlusions.

In summary, by combining the camera mounted on the robot wrist and the use of a pure vision algorithm, it is possible to fully exploit the intrinsic repeatability of the cobot and to greatly increase the precision of the apparatus compared to systems already on the market. It is also possible to design the pointing device according to the required precision, by using the configurable geometry of the pointing device. In fact, as described previously, the tracking mechanism involves local transformations and hence it possible to limit the error to almost the repetition error (i.e., to the intrinsic precision of a robot). In this way, the accuracy error is circumvented, which would appear instead if the robot were instructed to place its tool in precise coordinates in 3d space referred to an external reference system.

Furthermore, the accuracy of the device is uniform in space and does not depend on the distance between fixed sensors or emitters which may change.

Finally, unlike known solutions, the accuracy is not affected by noise and other disturbances sources which typically affect an industrial environment. In fact, the pose calculation does not involve emitters and receivers of e.g., electromagnetic or ultrasonic signals. Furthermore, the apparatus and method according to the invention are not even affected by the known drift problems of Inertial systems.

To conclude, from the description provided, it will be clear to those skilled in the art the advantage of the present invention in terms of positioning accuracy with respect to known systems.

### Conclusions

It has been found that the invention described hereinabove fully achieves the intended aim and objects.

In particular, it has been disclosed an apparatus and method for programming robots, preferably cobots, which are easy to install and implement, have high precision and a low cost. It shall be apparent to those skilled in the art that said apparatus and method represent a significant improvement in robot technology which is the result of a non-trivial inventive effort. To conclude, it is understood that the invention is not limited to the exemplary embodiments shown and described herein and although the description and examples provided contain many details, these should not be construed as limiting the scope of the invention but simply as illustrative illustrations of some embodiments of the present invention.

Hence, any modification of the present invention which falls within the scope of the following claims is considered to be part of the present invention.

Where the characteristics and techniques mentioned in any claim are followed by reference signs, these reference marks have been applied solely for the purpose of increasing the intelligibility of the claims and consequently these reference marks have no limiting effect on the interpretation of each element identified by way of example from these reference signs.

What is claimed:

1. Apparatus for programming (1) a robot (50) characterized by the fact of comprising:
pointing device (10) which can be placed in a point of the working space where said robot (50) operates;
a target (11), integral with said pointing device (10), comprising:
a target body (111) having a protruding element (112); and
a plurality of markers (113,113′) arranged according to a pattern on the surface of the body (111) and of the protruding element (112);
one or more mobile video cameras (20) integral with said robot (50), and optionally one or more fixed video cameras (60);
at least one processing unit (30) associated with said one or more cameras (20,60) or with said pointing device (10), said processing unit (30) storing an executable software;
activation means (12) which, once activated by an operator, allow said camera (20,60) in association with said software to detect in real time one or more positions and orientations in the working space of said target (11) and hence of the tool (52) mounted on said robot (50).

2. Apparatus for programming a robot according to claim 1, wherein said pointing device (10) has a body (102) designed to facilitate hand-gripping by an operator and wherein the target (11) is fixed to a lower (103) or upper (101) part of the body (102) of said pointing device (10), or the target (11) is slidingly constrained to said body (102) so as to allow the operator to move said target (11) to a position on said body (102) between a lower part (103) and an upper part (101).

3. Apparatus for programming a robot according claim 1 or 2, wherein:
said activation means (12) are in the form of buttons which, once activated by an operator, allow said camera (20,60) in association with said software to detect in real time a single position and orientation of said target (11) in the working volume, or a plurality of positions and orientations thereof;
said pointing device (10) is of the substantially passive type i.e. it includes an electronic unit configured to enable only communication to said processing unit (30) of the commands given by the operator through said activation means (12).

4. Apparatus for programming a robot according to claim 3, wherein said buttons (12) are positioned in the body (102) or, alternatively, are positioned on a separate portable device so that they are preferably activated by the hand that does not hold the pointing device (10), in order to guarantee the maximum stability of the pointing device (10) in high precision applications.

5. Apparatus for programming a robot according to claim 4, wherein said separate portable device is the robot teach-pendant.

6. Apparatus for programming a robot according claim 1 or 2, wherein:
said activation means (12) is a third software module for implementing a gesture- based input mode suitable for interpreting signs or gestures of the operator holding said pointing device (10), said third software module configured to detect in real time a single position and orientation of said target (11) in the working volume, or a plurality of positions and orientations thereof, said gesture-based input mode being optionally assisted by an aid worn by the operator to facilitate the visual and passive detection of said signs or gestures, said aid being a glove, a ring, or a bracelet;
said pointing device (10) is of the totally passive type i.e. it does not include any electronic units;
said at least one processing unit (30) is associated with said one or more cameras (20,60).

7. Apparatus for programming a robot according to one or more of claims 1 to 6 wherein said one or more mobile video cameras (20) are fixed to: the wrist of said robot (50), or to a movement axis of the robot itself, or to a movement axis integral with the robot and not belonging to said robot, or a combination thereof.

8. Apparatus for programming a robot according to one or more of claims 1 to 7 wherein said one or more fixed cameras (60) are: a main fixed camera (611) to detect dangerous conditions for the operator, an additional fixed camera (612) to localize said target (11) in the working space, or a combination thereof.

9. Apparatus for programming a robot according to one or more of claims 1 to 7 wherein said one or more cameras (20,60) is a single mobile camera (20) integral with said robot (50), said mobile camera being fixed to the wrist of said robot (50).

10. Apparatus for programming a robot according to one or more of claims 1 to 8 wherein said one or more video cameras (20,60) are:
a single mobile camera (20) integral with said robot (50), said mobile camera being fixed to the wrist of said robot (50); and
a single fixed camera (60) chosen between said main fixed camera (611) or alternatively said additional fixed camera (612).

11. Apparatus for programming a robot according to one or more of the preceding claims, wherein said computing unit (30) is integrated with said one or more video cameras (20,60).

12. A robot or a cobot comprising:
a pointing device (10) having a body (102) designed to facilitate hand-gripping by an operator;
a target (11) integral with said pointing device (10) comprising:
a target body (111) having a protruding element (112); and
a plurality of markers (113,113′) arranged according to a pattern on the surface of the body (111) and of the protruding element (112);
a single mobile camera (20) integral with said robot, preferably mounted on the wrist (51) of said robot;
a processing unit (30) associated with said pointing device (10) or with said single mobile camera (20), said processing unit (30) storing an executable software;
activation means (12) which, once activated by an operator, allow said camera (20) in association with said software to detect in real time a single position and orientation of said target (11) in the working space, or a plurality of positions and orientations thereof, and hence the position and orientation of the tool (52) mounted on said robot (50).

13. A robot or a cobot according to claim 12, which is mounted on a carriage so that said robot or a cobot can move along a track within the working space.

14. A robot or a cobot according to claim 12 or 13, which further includes one fixed video camera (60).

15. Method for programming the position and orientation of a tool (52) of a robot (50) in a working space by means of the apparatus according to one or more of claims 1 to 14, said method characterized in that it comprises the following steps:
a) make a mobile camera (20) integral with the robot (50), preferably by fixing it to the wrist (51) of said robot (50);
b) place a pointing device (10) having a marker pattern (113,113′) in said working space;
c) frame the marker pattern (113.113′) on said pointing device (10) by means of said mobile camera (20);
d) execute a software in a processing unit (30) associated with the pointing device (10), said software comprising instructions that cause a movement of the robot (50) such as to track the pattern (113,113′) while the operator, or other means, holds said pointing device (10), i.e. such as said pattern (113,113′) is framed by said mobile camera (20) remaining at a predetermined distance and inclination while the operator, or other means, holds said pointing device (10), wherein said predetermined distance and inclination are chosen so as to reduce the overall error in positioning and orientation;
e) optionally, change the positioning of the pattern (113.113′) with respect to the tip of said pointing device (10) in order to reduce the overall error in the positioning and orientation of said pointing device (10);
f) acting on the activation means (12) of said pointing device (10), detect the coordinates (x,y,z) and the orientation (α, β, γ) of the pattern (113,113′) with respect to said cameras (20,60) and calculate the pose ((x₀, y₀, Z₀), (α₀, β₀, γ₀)) of the pointing device (10) by means of a transformation T_{obj};
g) based on the relative pose ((x₁, y₁, z₁), (α₁, β₁, γ₁) of said camera (20) with respect to the tool (52) of the robot (50), and the pose ((x₂, y₂, z₂), (α₂, β₂, γ₂) of the tool (52) with respect to the base of said robot (50), operate a transformation T_{cam/tool} to calculate the pose ((x₃, y₃, z₃), (α₃, β₃, γ₃) of the pointing device (10) with respect to the robot base (50) and obtain the pose to be detected;
h) store the pose ((x₃, y₃, z₃), (α₃, β₃, γ₃) calculated in step g) to allow recall and use by the operator as needed.

16. Method for programming the position and orientation in space of a tool of a robot (50) according to claim 15, wherein said means which holds said pointing device (10) is an arm moved by an actuator or is a second robot.
